(19) United States
(12) Patent Application Publication
(10) Pub. No.: US 2009/0199715 A1
(43) Pub. Date: Aug. 13, 2009

(54) FILTER TUBE

(75) Inventors: Mike Koschak, Barcelona (ES); Sebastian Junqueras, Esplugues de Llobregat (ES)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinheim (DE)

(21) Appl. No.: 11/915,357

(22) PCT Filed: May 20, 2006
(86) PCT No.: PCT/EP2006/004805

§ 371 Date: Oct. 14, 2008

(30) Foreign Application Priority Data
Jun. 6, 2005 (DE) 10 2005 026 156.6

(51) Int. Cl. B01D 46/02

(52) U.S. Cl. 95/273; 55/376; 55/377

(57) ABSTRACT

A Filter bag for bag filter systems, comprising a tubular filter body which is closed at one end and has at the other end a retainer for attachment in the bag filter system, characterized in that the filter body is composed of a thermally bonded nonwoven.

### TECHNICAL FIELD

The invention relates to a filter bag for bag filter systems, comprising a tubular filter body which is closed at one end and has a retainer for attachment in the bag filter system.

### PRIOR ART

Filter bags and bag filter systems of this type are generally known. Bag filter systems are frequently employed for cleaning dust-laden gases in power plants. Multiple filter bags are combined in one bag filter system. To this end, the filter bags are mounted on a supporting body which is located on the clean-gas side. When gas flows through the filter bags from outside to inside, the gas is collected on the outer side of the bag and the cleaned gas passes from inside the filter bag to the clean-gas side. Filter bags can be dedusted by applying pressure impulses to the clean-gas side. As a result of the pressure impulse, the filter residue adhering to the filter bag is released and falls into a dust-collecting container on the dirty-gas side.

Filter bags are frequently made of needle felt. Needle felt is inexpensive and exhibits a low pressure drop. One disadvantage here is that due to the mode of fabrication needle felt has penetration sites which increase the porosity for particles.

### DESCRIPTION OF THE INVENTION

The problem solved by the invention is to provide a filter bag which has an improved collection efficiency.

This problem is solved by the features of claim 1. The subordinate claims relate to advantageous embodiments.

To solve the problem, the filter body is composed of a thermally bonded nonwoven. Due to their integrally bonded, partially superficially fused fibers, thermally bonded nonwovens have a small pore size. This enables a high collection efficiency to be achieved even for small particles. The nonwoven is of low thickness, and filtration is effected at the surface of the filter body due to the small pores. This aspect is advantageous compared with needle felts in which deep filtration occurs within the nonwoven. The particles continue to adhere to the surface and can be dedusted more easily. Dedusting is further enhanced by the smooth surface of the nonwoven produced by fusing processes. No additional coatings are required, with the result that the nonwoven can be provided inexpensively. The thermally bonding produces a nonwoven of high strength such that nonwovens having a mass per unit area of less than 500 g/m² can be employed for filter bags.

The nonwoven can be composed of a fiber mixture of high-melting-point and low-melting-point fibers, the fibers being bonded together by a fusing process. The fusing process here is operated at a temperature which is lower than the melting temperature of the high-melting-point fibers, and higher than or equal to the melting temperature of the low-melting-point fibers. Based on this mode of bonding, only the low-melting-point fibers are surface-fused, with the result that they are able to undergo a solid bonding to the high-melting-point fibers. Here it is exclusively the surface structures of the fibers that are affected, while the high-melting-point fibers remain virtually unaffected. The low-melting-point fibers here function as binding fibers, while the high-melting-point fibers function as structural fibers. The fibers of the nonwoven can comprise polyolefin fibers or polyester fibers. The polyester fibers here can be composed of polyethylene terephthalate or polybutylene terephthalate. The provision of fibers composed of polyolefins or polyesters makes possible a fixation to other fibers within the nonwoven. A conceivable approach here is to have a highly fibrillated polyethylene fiber material thermally fixed to low-melting-point polyolefin fibers or polyesters. In the case of thermal fixation, however, it is only the binding fibers that are surface-fused and modified in terms of their surface properties, whereas the pulp material as well as the structural fibers are not affected by the thermal fixation process.

The entire surface of the nonwoven can be continuously bonded. The entire-surface-continuous bonding can be effected, for example, in a heating calendar. This approach inexpensively provides a complete finishing of the nonwoven having the advantageous properties of the thermally bonded nonwoven. In other embodiments, bonding is effected on a point-by-point basis.

The nonwoven can comprise fused bicomponent fibers. One component here has a lower melting point than the other fibers. For example, it is conceivable that one component comprise polyethylene and the other one comprise polypropylene. Based on this embodiment, a nonwoven is feasible in which one fiber functions simultaneously as a binding fiber and a structural fiber. In particular, it is conceivable here that, for example, the core of the bicomponent fiber be composed of a high-strength material, and one melting at a higher temperature, such as polypropylene, while the sheath composed of polyethylene could melt at a very low temperature. Based on this concrete embodiment, bicomponent fibers are especially suitable for the thermal fixation of fiber blends since they are able to create a bond with the fiber material even at very low melting temperatures, and after bonding can function as structural fibers. In this process, it is only the sheath surface of the bicomponent fibers which is surface-melted, thereby enabling the bicomponent fibers to form a bond with the fiber material.

The nonwoven can be grooved. This increases the filter surface area of the filter body, and the result is an improved elasticity of the filter body radially, thereby improving the dedusting capability. Due to the grooving, the filter body is dimensionally stable, in particular, in the axial direction.

The filter body can have three-dimensional structures. The structures can be incorporated in the filter body either in addition to or in place of the grooving. Possible structures are, for example, raised or recessed knobs or corrugations. The structures can be permanently incorporated in the filter body by deep drawing. Due to the structure, the filter surface area and flexibility of the filter body is increased.

The nonwoven can have a coating. The coating can be composed of nanofibers, the fiber diameter of which is less than 1 μm or composed of a PTFE coating. This coating increases yet again the collection efficiency of the filter. Other possible coatings can be applied to the filter body using plasma treatments or dip coatings. Depending on the implementation, the filter body can be finished so as to be hydrophilic/hydrophobic and/or oleophilic/oleophobic. An additional coating is created by vapor-deposition of a metallic material. This metal vapor deposition enables the filter body to be antistatically finished, thereby reducing the fire hazard. An additional antistatic finishing is achieved with incorporated metal threads or imprinted carbon structures.

A coating with salts, for example boric salts, enables the filter body to be finished so as to be flame retardant.

The filter body can have a longitudinally running seam which is integrally sealed. As a result, the filter body can be produced easily and inexpensively from web material. Integral bonds can be implemented using simple means so as to be gas-tight.

The seam can be welded. Welding is simple and inexpensive. The seam here can be sealed by ultrasonic techniques. This method requires auxiliary agents and the seam is sealed so as to be gas-tight.

One end can be closed by a cover composed of needle felt. The closed end is located in the inflow direction on the dirty gas side and is therefore exposed to increased abrasion by the fast-flowing particles. The cover composed of needle felt prevents the filter body from wearing out prematurely.

The cover can have a ring which is disposed on the outer circumference of the filter body, and can have a cap disposed on the inner circumference of the filter body, which cap has a cylindrical segment disposed opposite the ring, the ring, filter body, and segment being sewn together. The result is an especially strong and secure attachment of the cover to the filter body. The cover has a large amount of material which prevents premature wear.

The retainer can be composed of a snap-in ring. A snap-in ring is a secure and quickly detachable attachment means.

The snap-in ring can have a jacket composed of needle felt, the jacket being sewn on to the filter body. As a result, the snap-in ring is protected from damage.

### BRIEF DESCRIPTION OF THE DRAWINGS

Several embodiments are described in more detail below based on the figures. These are, in case each schematically:

FIG. 1 showing a filter bag according to the invention;

FIG. 2 showing a filter bag system.

### REALIZATION OF THE INVENTION

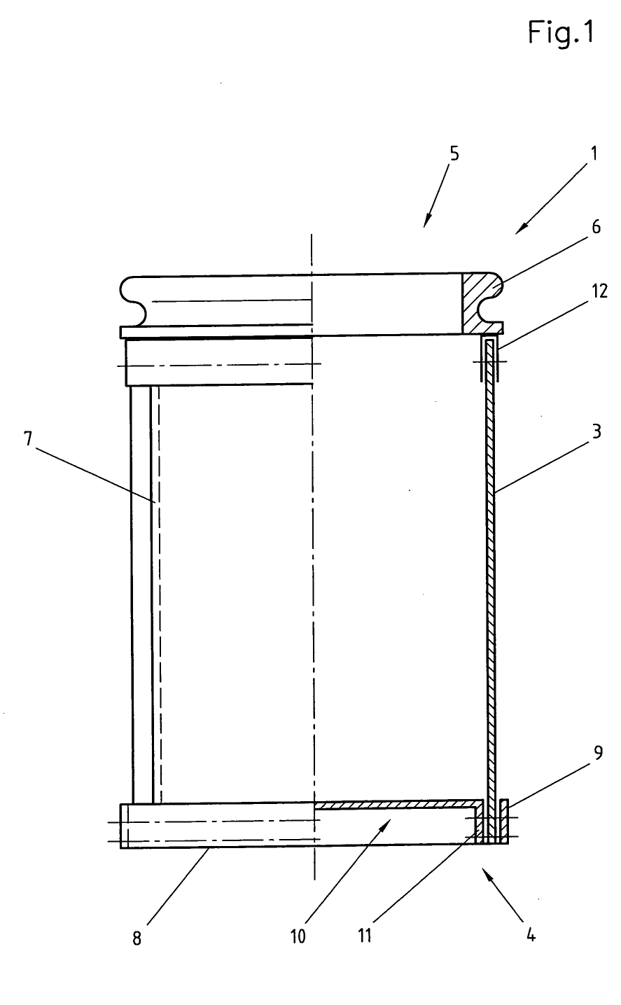

FIG. 1 shows a filter bag 1 for bag filter systems 2. Filter bag 1 is composed of a tubular filter body 3 which consists of a thermally bonded nonwoven. The nonwoven is thermally bonded continuously over the entire surface and comprises bicomponent fibers. The bicomponent fibers have a core composed of high-melting-point polypropylene and a sheath composed of a low-melting-point polyethylene. Filter body 3 has a longitudinally running seam 7 which is integrally sealed by means of ultrasonic welding and so as to be gas-tight. In addition, filter body 3 is grooved axially. At one end 4, filter body 3 is closed by a cover 8 composed of needle felt. Cover 8 consists of a ring 9 which is disposed on the outer circumference of filter body 3 and of a cap 10 disposed on the inner circumference of filter body 3, which cap has a cylindrical segment 11 which is disposed opposite ring 9. Ring 9, filter body 3, and segment 11 are sewn together. Disposed on the other end 5 is a retainer 6 for attachment in bag filter system 2, the retainer being composed of a snap-in ring. Retainer 6 has a jacket 12 composed of needle felt which is sewn on to filter body 3.

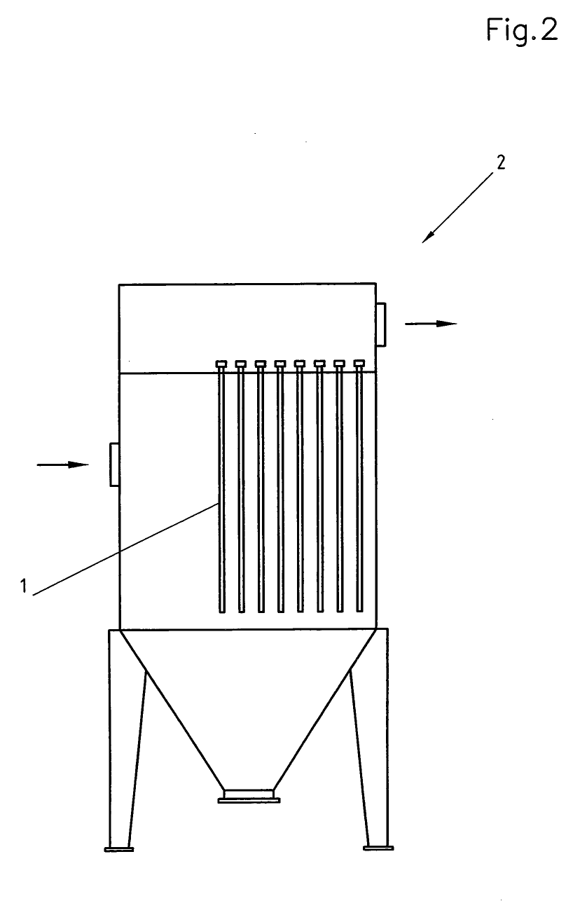

FIG. 2 shows a bag filter system 2 for stationary dust-removal systems in power plants in which filter bags 1 of FIG. 1 are mounted.

What is claimed is:

1. Filter bag for bag filter systems, comprising a tubular filter body which is closed at one end and has at the other end a retainer for attachment in the bag filter system, wherein the filter body is composed of a thermally bonded nonwoven.

2. The Filter bag according to claim 1, wherein the nonwoven is bonded continuously over its entire surface.

3. The Filter bag according to claims 1, wherein the nonwoven comprises fused bicomponent fibers.

4. The Filter bag according to claim 1, wherein the nonwoven is grooved.

5. The Filter bag according to claim 1, wherein the filter body has three-dimensional structures.

6. The Filter bag according to claim 1, wherein the nonwoven has a coating.

7. The Filter bag according to claim 1, wherein the filter body has a longitudinally running seam which is integrally sealed.

8. The Filter bag according to claim 7, wherein the seam is welded.

9. The Filter bag according to claim 1, wherein the one end is closed by a cover composed of needle felt.

10. The Filter bag according to claim 9, wherein the cover has a ring which is disposed on the outer circumference of the filter body, and has a cap disposed on the inner circumference of the filter body, said cap having a cylindrical segment which is disposed opposite the ring, ring, filter body, and segment being sewn together.

11. The Filter bag according to claim 1, wherein the retainer is composed of a snap-in ring.

12. The Filter bag according to claim 1, wherein the retainer has a jacket composed of needle felt, the jacket being sewn on to the filter body.

13. Use of the filter bag according to claim 1 in a stationary dust-collecting system
